(19) United States
(12) Patent Application Publication
(10) Pub. No.: US 2005/0182156 A1
(43) Pub. Date: Aug. 18, 2005

(54) Glove made with non-toxic plasticizer ATBC

(76) Inventor: Guixi Liu, Shijiazhuang (CN)

Correspondence Address: Donald W. Meeker;Patent Agent, 924 East Ocean Front #E, Newport Beach, CA, 92661, US

(21) Appl. No.: 10/781,156

(22) Filed: Feb. 18, 2004

(51) Int. Cl. C08K 9/02

(52) U.S. Cl. 523/204

(57) ABSTRACT

A combination of materials in a PVC/Nitrile glove fabricated from a conventional manufacturing process comprising approximately 50% Polyvinyl Chloride (PVC) powder, approximately 45% O-Acetyl Tributyl Citrate (ATBC); and approximately 5% TXIB and a stabilizer (CZ-115).

### BACKGROUND OF THE INVENTION

1. Field of the Invention

The present invention relates to flexible gloves and particularly to a glove made from approximately 50% polyvinyl chloride (PVC) powder, 45% O-Acetyl Tributyl Citrate (ATBC) plasticizer and other additives 5%, which is non-toxic and may be used for medical or non-medical purposes.

2. Description of the Prior Art

Flexible latex, nitrile or PVC gloves are well known and have plasticizers added to their composition in an amount sufficient to reduce brittleness, increase wear, and improve flexibility. Plasticizers are well known in the art and can be selected from, but not limited to: phthalic acid ester, glycol ester, fatty acid ester, and phosphoric acid ester. Examples of commercially available plasticizers are epoxidised soybean oil (ESO) and dioctyl phthalate (DOP). DOP has been found to be toxic and creates health risks, which include decreased blood pressure and respiration, central nervous system toxicity, decreased birth weight in male offspring, and cancer is indicated by some tests. All PVC finished objects are essentially inert but there is always a little amount of plasticizer that doesn't react with the PVC and then the DOP will come off onto fingers and anything contacted by the gloves, including direct contact with food or skin. European regulation has banned the use of phtalates in packages for food, blood containers and water bottles.

Acetyl tributyl citrate (ATBC) has been found to be a non-toxic plasticizer, which may be added to PVC, PVDC or PVAc Acetyl Tributyl Citrate is a plasticizer or carrier solvent permitted in the field of food additive, food contact material as well as for polymers specially for cellulosics. It is also used in synthesis flavoring substances and adjuvants. ATBC can be used as a component of adhesives and is also widely used in medical products and toys.

Prior art patents do not adequately address the usage of ATBC in a desirable amount and in a desirable proportion of the mixture with other materials to create a glove material with optimum desirable characteristics.

U.S. Patent Application #20030157150, published Aug. 21, 2003 by Lee, describes the formulation and process for manufacturing antimicrobial vinyl gloves. The formulation comprises a PVC resin, a plasticizer blend, a stabilizer, a powdered antimicrobial agent, a surfactant and a dispersing agent. A process for manufacturing an antimicrobial PVC glove is also provided. Firstly, an effective amount of a powered antimicrobial agent is allowed to suspend in a polymer plastisol including a PVC resin, a plasticizer blend, a stabilizer, a surfactant and a dispersing agent. Then, a shape of the glove is dipped into a mixture of the polymer plastisol and powered antimicrobial agent. Then, the mixture on the shape is cured so as to form the glove.

U.S. Patent Application #20030013828, published Jan. 16, 2003 by Shimada, discloses a polyvinyl chloride dispersion resin from which a product having excellent clarity and heat resistance can be obtained, and which has improved pulverization efficiency and increased recovery percentage in the production process, a plastisol composition and a plastigel composition using the same. The polyvinyl chloride dispersion resin of the present invention is obtained by polymerization using 0.1 to 5.0 parts by weight of an ammonium salt emulsifier based on 100 parts by weight of a vinyl chloride monomer, wherein the polyvinyl chloride dispersion resin has a specific surface area of 5 to 10 m.sup.2/g and comprises (A) 10 to 60% by weight of a particle having a particle diameter distribution of less than 0.5 .mu.m and having at least one peak diameter of the distribution in the range of at least 0.1 .mu.m to less than 0.5 .mu.m and (B) 40 to 90% by weight of a particle having a particle diameter distribution of at least 0.5 .mu.m and having at least one peak diameter of the distribution in the range of at least 0.5 .mu.m to at most 1.3 .mu.m.

U.S. Patent Application #20020161156, published Oct. 31, 2002 by Nkansah, indicates novel compositions useful in coating, adhesive, structural, film, sheet, pipe, toys, house siding, asphalt, thermoplastic, elastomer and other applications. The novel compositions comprise copolymers of at least one vinyl and/or vinylidene monomer and at least one high reactivity polyolefin. The copolymers are produced by polymerizing at least one high reactivity polyolefin and at least one vinyl monomer in the presence of a free radical initiator.

U.S. Pat. No. 4,210,567, issued Jul. 1, 1980 to Kosters, provides a plastisol of an acrylate polymer and a plasticizer. The plastisol is based on selected plasticizers and on polymers of certain acrylic or methacrylic monomers, viz. mainly (i) t-butyl acrylate, a C.sub.1-4 alkyl, especially methyl, acrylate or cyclohexyl methacrylate, and optionally also (ii) one or more comonomers selected from methacrylates of aliphatic C.sub.2 to C.sub.10 alcohols, acrylates of aliphatic C.sub.1 to C.sub.10 alcohols, styrene and alpha-methyl styrene. The glass transition temperature of the polymer is above 35 degree. C., its average degree of polymerization more than 400 and its average particle size in the plastisol is 0.1 to 500 microns.

U.S. Pat. No. 5,444,113, issued Aug. 22, 1995 to Sinclair, shows end use applications of biodegradable polymers. Sinclair discloses products made of degradable materials, which include a hydrolytically degradable polymer. The degradable materials can be internally or externally modified. The internally modified polymer composition has polymers modified by the use of comonomers having a relatively high molecular weight. The externally modified polymer composition includes a modifier, wherein the modifier is compatible with the polymer and the modifier is nontoxic, nonvolatile and nonfugitive. The various degradable materials include films, fibers, extruded and molded products, laminates, foams, powders, nonwovens, adhesives and coatings. The disclosed materials are particularly useful for the production of a variety of products in high volumes which are suitable for recycling after use or which are discarded into the environment in large volumes.

U.S. Pat. No. 5,760,118, issued Jun. 2, 1998 to Sinclair, claims end use applications of biodegradable polymers. Disclosed are products made of degradable materials, which include a hydrolytically degradable polymer. The degradable materials can be internally or externally modified. The internally modified polymer composition has polymers modified by the use of comonomers having a relatively high molecular weight. The externally modified polymer composition includes a modifier, wherein the modifier is compatible with the polymer and the modifier is nontoxic, nonvolatile and nonfugitive. The various degradable materials include films, fibers, extruded and molded products, laminates, foams, powders, nonwovens, adhesives and coatings. The disclosed materials are particularly useful for the production of a variety of products in high volumes which are suitable for recycling after use or which are discarded into the environment in large volumes.

U.S. Pat. No. 5,834,582, issued Nov. 10, 1998 to Sinclair, describes a degradable polymer composition. Disclosed are degradable materials, which include a nontoxic hydrolytically degradable polymer and nontoxic modifier, wherein the modifier is compatible with the polymer and the modifier is nonvolatile and nonfugitive. Also disclosed are processes for forming the various degradable materials, which include films, molded products, laminates, foams, powders, nonwovens, adhesives and coatings. The disclosed materials and processes are particularly useful for the production of commercial and consumer products in high volumes which are suitable for recycling after use or which are discarded into the environment in large volumes.

U.S. Pat. No. 5,502,158, issued Mar. 26, 1996 to Sinclair, discloses a degradable polymer composition. Disclosed are degradable materials, which include a nontoxic hydrolytically degradable polymer and nontoxic modifier, wherein the modifier is compatible with the polymer and the modifier is nonvolatile and nonfugitive. Also disclosed are processes for forming the various degradable materials, which include films, molded products, laminates, foams, powders, nonwovens, adhesives and coatings. The disclosed materials and processes are particularly useful for the production of commercial and consumer products in high volumes which are suitable for recycling after use or which are discarded into the environment in large volumes.

U.S. Pat. No. 5,677,053, issued Oct. 14, 1997 to Moriga, indicates an adhesion structure in which the gel of an acrylic plastisol is strongly adhered to the metallic base material, featuring excellent resistance against corrosion and exhibiting small whitening tendency even under severe conditions for treatment with hot water such as retort processing, and a method of producing the same structure. The acrylic plastisol is applied onto the metallic base material or onto the metallic base material having an organic coating provided with a layer of a thermosetting resin which contains a bisphenol-type epoxy resin and a phenolic resin at a weight ratio of from 99:1 to 85:15, and is gelled by heating and is, at the same time, adhered to the base material via the thermosetting resin layer. The acrylic plastisol is gelled and is strongly adhered onto the thermosetting resin layer within short periods of time. The obtained adhesion structure exhibits excellent resistance against peeling, corrosion and retorting.

U.S. Pat. No. 6,136,905, issued Oct. 24, 2000 to Suzuki, puts forth L-lactic acid polymer composition, molded product and film. The lactic acid polymer composition comprises formulating 1.00 parts by weight of a mixture consisting of 80-95% by weight of an L-lactic acid polymer having an L-lactic acid proportion of 75% or more and 5-20% by weight of a plasticizer selected from the group consisting of a polyhydric alcohol ester and a hydroxypolycarboxylic acid ester, 0.1-5 parts by weight of an anti-blocking agent having a SiO.sub.2 content of 90% or more and an average particle size of 7-50 nm, and 0.1-2 parts by weight of a slip agent; a molded product and film obtained from the composition; and a preparation process of the same are disclosed. The molded product and film are excellent in processability, transparency, flexibility, anti-blocking property and slip, and can be degraded into harmless water and carbon dioxide under natural environment, when abandoned.

U.S. Pat. No. 5,763,513, issued Jun. 9, 1998 to Suzuki, illustrates L-lactic acid polymer composition, molded product and film. The lactic acid polymer composition comprises formulating 100 parts by weight of a mixture consisting of 80-95% by weight of an L-lactic acid polymer having an L-lactic acid proportion of 75% or more and 5-20% by weight of a plasticizer selected from the group consisting of a polyhydric alcohol ester and a hydroxypolycarboxylic acid ester, 0.1-5 parts by weight of an anti-bloking agent having a SiO.sub.2 content of 90% or more and an average particle size of 7-50 nm, and 0.1-2 parts by weight of a slip agent; a molded product and film obtained from the composition; and a preparation process of the same are disclosed. The molded product and film are excellent in processability, transparency, flexibility, anti-blocking property and slip, and can be degraded into harmless water and carbon dioxide under natural environment, when abandoned.

U.S. Pat. No. 5,525,646, issued Jun. 11, 1996 to Lundgren, concerns a bioresorbable material and an article of manufacture of such material for medical use. The bioresorbable material comprises homopolymers, copolymers, or a blend thereof selected from the group of monomers including glycolic acid, lactic acid, caprolactone, trimethylene carbonate, paradioxanone and 1,5 dioxepan-2-one, a plasticizer selected from the group including ethyl, butyl and hexyl esters of acetylated or non-acetylated citric acid, ethyl terminated oligomers of lactic acid, having no less than 2 and no more than 10 units, and lactic acid esters of glycerol, the material comprises 50% of amorphous polymer or polymers to impart to the material plastic malleability substantially without memory.

U.S. Pat. No. 6,016,570, issued Jan. 25, 2000 to Vande Pol, is for a powder-free medical film glove that comprises an elastomer base layer having a sprayed, intermittent coating formed on the hand-contacting surface of the glove. The glove of the present invention improves donning by reducing intersurface tack, improves tactile sensory transmittance, and reduces unnecessary material consumption.

U.S. Pat. No. 5,881,386, issued Mar. 16, 1999 to Horwege, provides a two layer flexible article that includes a first layer of polyvinyl chloride (PVC) and a second layer of polyester polyurethane, which incorporates a texturizing agent. The article preferably is a glove formed by the method of dipping a hand shaped form into a first bath containing a PVC plastisol and a second bath containing a polyester polyurethane emulsion incorporating a texturizing agent and a slip agent. In a finished glove of the present invention the PVC layer forms the outside or patient contacting surface and the polyester polyurethane with the texturizing agent and the slip agent incorporated therein forms the inner user contacting surface. Gloves of the present invention are substantially donnable without the need for donning powders.

U.S. Pat. No. 3,059,241, issued Oct. 23, 1962 to O'Brien, shows a relatively thin gauge dipped plastic surgeon's glove. The glove is produced from a glove-forming cement formulation containing a vinyl chloride-vinyl acetate copolymer plasticized with polymeric plasticizers, such as Plastolein No. 9205, which is a tetrahydrofurfuryloleate plasticizer for vinyl resins produced by Emery Industries.

What is needed is a PVC glove made with the most desirable characteristics by using an optimum amount of ATBC in proportion to the PVC and other substances used in making the glove.

### SUMMARY OF THE INVENTION

An object of the present invention is to provide a PVC glove made with the most desirable characteristics by using an optimum amount of ATBC (approximately 45%) as a plasticizer in proportion to the PVC (approximately 50%) and other substances (approximately 5%) used in making the glove to create a non-toxic, stable, inert glove which has more elongation and does not give off any material to the wearer of the gloves or to anything touched by the gloves.

Another related object of the present invention is to provide a PVC glove with the above proportion of ABTC as a non-toxic plasticizer so that the glove decreases blood pressure and respiration, reduces central nervous system toxicity, and in not known to cause cancer.

In brief, PVC/Nitrile gloves for medical or non-medical use are made from approximately 50% PVC (Polyvinyl Chloride) powder, 45% ATBC (O-Acetyl Tributyl Citrate) as the plasticizer, and 5% other additives, including a stabilizer using a conventional manufacturing process.

An advantage of the present invention is that it creates PVC/Nitrile gloves which are non-toxic and do not give off any material and have more elongation.

Another advantage of the present invention is that it does not produce ill effects associated with other related gloves using a different plasticizer.

### BEST MODE FOR CARRYING OUT THE INVENTION

A combination of materials in a PVC/Nitrile glove fabricated from a conventional manufacturing process comprising: approximately 50% Polyvinyl Chloride (PVC) powder; approximately 45% O-Acetyl Tributyl Citrate (ATBC); and approximately 5% TXIB and a stabilizer (CZ-115).

A narrow range of composition of each material produces the desirable glove characteristics of non-toxicity and stable material which does not rub off of the glove and having desirable elongation properties.

Two types of Polyvinyl Chloride (PVC) are preferably used including 37.83%-39.80% PVC (LP-170G) obtainable from LG International Corporation and 9.46%-9.95% PVC (EH2075) obtainable from Hanwha Corporation.

The plasticizer is preferably 44.71%-44.91% O-Acetyl Tributyl Citrate (ATBC) obtainable from Anshan Huayi Plastic. The chemical formula for the ATBC is C₂₀H₃₄O₈ with a molecular weight of 402.48. The standard specifications include an assay of 99.0% minimum, a color value APHA of 50 maximum, an acid value of 0.2 mgKOH/g maximum, a loss on drying of 0.5% maximum, a moisture of 0.25% maximum, and heavy metals 1 ppm maximum. The physical properties include a boiling point at 1 torr of 173° C., a melting point of −80° C., a density at 25° C. of 1.053, and a refractive index of 1.441.

The main additive is preferably 4.98%-7.09% TXIB obtainable from Eastman Chemical.

The stabilizer is preferably 0.50%-0.71% CZ-115 obtainable from Golden Chemical Corporation.

The preferred combination of materials in the PVC/Nitrile glove of the present invention fabricated from a conventional manufacturing process comprises:
37.83%-39.80% Polyvinyl Chloride (PVC) powder (LP-170G);
9.46%-9.95% Polyvinyl Chloride (PVC) powder (EH2075);
44.71%-44.91% O-Acetyl Tributyl Citrate (ATBC);
4.98%-7.09% TXIB; and
0.50%-0.71% stabilizer (CZ-115).

It is understood that the preceding description is given merely by way of illustration and not in limitation of the invention and that various modifications may be made thereto, including substitutions of like materials without departing from the spirit of the invention as claimed.

1. A combination of materials in a PVC/Nitrile glove fabricated from a conventional manufacturing process, the combination of materials comprising:
approximately 50% Polyvinyl Chloride (PVC) powder;
approximately 45% O-Acetyl Tributyl Citrate (ATBC); and
approximately 5% TXIB and a stabilizer (CZ-115).

2. The combination of materials of claim 1 wherein the PVC comprises:
37.83%-39.80% PVC (LP-170G); and
9.46%-9.95% PVC (EH2075).

3. The combination of materials of claim 1 comprising 44.71%-44.91% O-Acetyl Tributyl Citrate (ATBC).

4. The combination of materials of claim 1 comprising 4.98%-7.09% TXIB.

5. The combination of materials of claim 1 comprising 0.50%-0.71% stabilizer (CZ-115).

6. A combination of materials in a PVC/Nitrile glove fabricated from a conventional manufacturing process, the combination of materials comprising:
37.83%-39.80% Polyvinyl Chloride (PVC) powder (LP-170G);
9.46%-9.95% Polyvinyl Chloride (PVC) powder (EH2075);
44.71%-44.91% O-Acetyl Tributyl Citrate (ATBC);
4.98%-7.09% TXIB; and
0.50%-0.71% stabilizer (CZ-115).
